(19) United States
(12) Patent Application Publication
(10) Pub. No.: US 2022/0319242 A1
(43) Pub. Date: Oct. 6, 2022

(54) METHOD AND DEVICE FOR PROVIDING MAINTENANCE INFORMATION ON A DOOR SYSTEM FOR A VEHICLE, AND DOOR SYSTEM FOR A VEHICLE

(71) Applicant: KNORR-BREMSE GESELLSCHAFT MIT BESCHRÄNKTER HAFTUNG, Mödling (AT)

(72) Inventors: Johann BRAMAUER, Ybbsitz (AT); Reinhard EKKER, Scheibbs (AT)

(21) Appl. No.: 17/642,876

(22) PCT Filed: Sep. 10, 2020
(86) PCT No.: PCT/EP2020/075285

§ 371 Date: Mar. 14, 2022

(30) Foreign Application Priority Data
Sep. 13, 2019 (EP) 1919156.3

(51) Int. Cl. G07C 5/00; E05F 15/60; B61L 27/57

(52) U.S. Cl. CPC G07C 5/006; E05F 15/60; B61L 27/57; E05Y 2201/434; E05Y 2400/502; E05Y 2400/44; E05Y 2800/404; E05Y 2900/531; E05Y 2900/51

(57) ABSTRACT

A method providing maintenance information on a door system for a vehicle that includes reading detected process data with respect to a movement process of a door of the door system, the process data representing a current behavior of at least one drive element of the door system during the movement process, correlating the process data to a position curve of positions of the door during the movement process to generate a characteristic line of the current behavior of the at least one drive element at the positions of the door, comparing the characteristic line with a reference characteristic line which represents a target behavior of the at least one drive element at positions of the door to ascertain a deviation of the characteristic line from the reference characteristic line, and assigning the deviation to a sub-region of the position curve, which is divided into a plurality of sub-regions based on the involvement of different movement elements of the door system in different phases of the movement process of the door to determine the maintenance information.

### CROSS REFERENCE AND PRIORITY CLAIM

This patent application is a U.S. National Phase of International Patent Application No. PCT/EP2020/075285 filed Sep. 10, 2020, which claims priority to European Patent Application No. 19197156.3, the disclosure of which being incorporated herein by reference in their entireties.

### FIELD

Disclosed embodiments relate to a method for providing maintenance information on a door system for a vehicle, a corresponding device, and a door system for a vehicle, in particular for a rail vehicle.

### BACKGROUND

Algorithms can be used for state-dependent maintenance and predictive maintenance, in particular, to predict future states from process data and environmental data.

### SUMMARY

Against this background, disclosed embodiments provide an improved method for providing maintenance information on a door system for a vehicle, an improved device for providing maintenance information on a door system for a vehicle, and an improved door system for a vehicle.

### BRIEF DESCRIPTION OF FIGURES

Exemplary embodiments of the approach presented here are explained in more detail in the following description with reference to the figures. In the figures:

FIG. 1 shows a schematic illustration of a vehicle having a door system according to one exemplary embodiment;

FIG. 2 shows a schematic diagram of a reference characteristic curve according to one exemplary embodiment;

FIG. 3 shows a schematic comparison diagram of a characteristic curve and a reference characteristic curve according to one exemplary embodiment; and

FIG. 4 shows a flow chart of a method for providing according to one exemplary embodiment.

### DETAILED DESCRIPTION

According to embodiments, a segmentation of a door running action according to kinematic elements or with regard to elements of the door system participating in different movement phases can be performed in particular for the purpose of maintenance of a door system of a vehicle, in particular a rail vehicle. In this case, for example, if deviations are established between a target behavior and an actual behavior of a door drive with regard to maintenance, those elements of the door system can be taken into consideration which also actually have a component of a movement behavior of the door in the respective movement phase.

Advantageously, according to embodiments, in particular a state of a system or a component can be predicted, for example, in the meaning of state-dependent maintenance or predictive maintenance. In this case, an assignment of anomalies recognized by algorithms to specific error patterns can also be improved, even if drive systems used sometimes behave very differently within individual movement phases. Due to the segmentation of the door running action according to movement phases, in particular an assignment of recognized anomalies to specific error patterns can be implemented based on the respective movement phase of the door running action. A plausibility check of collected items of sensor information of a door system or entry system can also be enabled, for example, by assigning them to the individual kinematic subsections or sections of the door running action. The informative value and utility of applied algorithms for state-dependent maintenance or predictive maintenance can, thus, be improved.

Therefore, by classifying the door running action into movement phases each having participating elements, in particular anomalies in recorded signals can be compared to the movement phases and participating elements. For example, individual error patterns can be excluded as the cause of an anomaly, since they do not participate at all in the kinematic phase of the door running action in question. A more specific statement can, thus, be made with regard to the underlying error pattern. Anomalies can no longer be evaluated as a whole over the entire door running action, but rather observed deliberately with respect to individual kinematic elements. This can in particular enable a more accurate assignment to a real error pattern. Moreover, a higher prediction quality can also be achieved by the focused manner of observation. Furthermore, a plausibility check or a combination of collected process data and additionally or alternatively environmental data can be implemented on the basis of the movement phase of the door running action of the respective entry system. A prediction quality of algorithms for state-dependent maintenance and predictive maintenance can, thus, be increased.

A method for providing maintenance information on a door system for a vehicle has the following operations:

inputting acquired process data with respect to a movement process of a door of the door system, wherein the process data represent a current behavior of at least one drive element of the door system during the movement process;

correlating the process data with a position course of positions of the door during the movement process to generate a characteristic curve of the current behavior of the at least one drive element at the positions of the door;

comparing the characteristic curve to a reference characteristic curve which represents a target behavior of the at least one drive element at the positions of the door to ascertain a deviation of the characteristic curve from the reference characteristic curve; and

assigning the deviation to a subsection of the position course divided into a plurality of subsections in dependence on a participation of different movement elements of the door system in different phases of the movement process of the door, to determine the maintenance information.

This method or the operations of the method can be implemented, for example, in software or hardware or in a mixed form made up of software and hardware, for example in a device or a control unit. The method can also be executed in a stationary device (server for data evaluation), wherein the sensor data are acquired by a device on the train and transmitted via one or more systems.

The vehicle can be a vehicle for passenger conveyance, for example a rail vehicle.

The movement process of the door can be an opening process, a closing process, or a door cycle including an opening process and a closing process of the door. The movement process is divided into a sequence of phases. The phases can represent, for example, unlocking, pivoting out, linear movement, pivoting in, and locking. Different movement elements can participate in the movement process of the door in the different phases. Two successive phases can differ in the participating movement elements. Therefore, at least one movement element can be assigned to each phase which primarily participates in the movement process within this phase. Participating movement elements can be at least one locking unit, at least one pivot unit, and at least one guide unit.

During the movement process, the door passes through a sequence of positions. The door can assume the positions during the movement process relative to a door frame or a vehicle chassis. The sequence of positions is referred to as the position course. The position course is divided into a plurality of subsections, wherein each phase of the movement process can be assigned a subsection of the position course.

The process data can represent data acquired by an acquisition unit of the vehicle or the door system during the movement process. The acquisition unit can comprise at least one sensor, which is coupled to the door or at least one door element. For example, the acquisition unit can be designed to acquire a current flow through a drive to carry out the movement process. The process data can, therefore, represent a sequence of measured values acquired using the acquisition unit during the movement process. The process data can be input in the form of an electrical input signal via an interface, for example to the acquisition unit.

In the operation of correlating, an assignment can be carried out between the process data and the positions of the position course. In the operation of correlating, each position can, therefore, be assigned, for example, a measured value which was acquired at the point in time at which the door occupied the corresponding position. The operations of inputting and correlating can be carried out in chronological succession. Alternatively, the operations of inputting and correlating can be carried out at the same time, for example, in that a measured value is acquired at each position of the position course.

The reference characteristic curve can be predetermined and input, for example, via an interface to a storage unit. In the operation of comparing, the characteristic curve and the reference characteristic curve can be compared using a suitable method, for example, in the time range and/or in the frequency range. For example, the deviation can represent a difference between the characteristic curve and the reference characteristic curve which meets a predetermined criterion.

In that the deviation is assigned to a subsection and, thus, a phase, the movement element which participates in the movement process in this phase can be determined. There is a high probability that the deviation is to be attributed to a change of the function of this movement element. The maintenance information can, thus, comprise a reference to the movement element by which the deviation was caused. The maintenance information can have quantitative and additionally or alternatively qualitative specifications with respect to the deviation, the position, the subsection, and additionally or alternatively at least one movement element. The maintenance information can be provided in the form of an electrical output signal. For example, the maintenance information can be used to activate a warning unit, stored in an error memory, or further processed by a suitable unit.

According to one embodiment, the method can have a operation of dividing the position course into the plurality of subsections in dependence on a participation of the different movement elements of the door system in the different phases of the movement process of the door. For this purpose, a determination of the phases of the movement process or door running action can be carried out by measuring at an entry of the production series of the vehicle to be monitored, creating a phase model, and additionally or alternatively providing the phase model in suitable form. Such an embodiment offers the advantage that a suitable phase model can be used as the basis for each design of the door system.

In the operation of assigning, first maintenance information can also be determined if the deviation is assigned to a first subsection of the movement process in which a first subset of the movement elements participates. Furthermore, in the operation of assigning, second maintenance information different from the first maintenance information can be determined if the deviation is assigned to a second subsection of the movement process in which a second subset of the movement elements participates. The second subset can differ at least partially from the first subset. Such an embodiment offers the advantage that references to possible error sources or movement elements to be taken into consideration in particular with regard to the maintenance can be provided, so that maintenance can be facilitated.

In particular, in the operation of inputting, the process data can be input in response to a door opening signal and additionally or alternatively in response to a door closing signal. Such an embodiment offers the advantage that an accurate chronological reference is available for the correlation.

According to one embodiment, in the operation of inputting, process data can be input which represent a power consumption of the at least one drive element. Additionally or alternatively, in the operation of inputting, a sensor signal can be input which represents the positions of the door during the movement process. The at least one drive element can be an electric motor or another positioning element. Such an embodiment offers the advantage that inferences about a maintenance state of the door system can be drawn in a simple and reliable manner.

Moreover, the method can have a operation of outputting the determined maintenance information at an interface to a unit for executing an algorithm for state-dependent maintenance and additionally or alternatively an algorithm for predictive maintenance. The maintenance information can be used as an input variable for algorithms of state-dependent maintenance and additionally or alternatively predictive maintenance. Such an embodiment offers the advantage that a prediction quality of such algorithms can be further improved.

At least one of the operations of the method can be executed partially or entirely externally to the vehicle. The method can, therefore, be executed completely or partially not at the vehicle but rather in a device arranged separately from the vehicle for ascertaining the maintenance state.

The approach presented here furthermore provides a device for providing maintenance information on a door system of a vehicle, which is designed to carry out, activate, or implement the operations of a variant of a method presented here in corresponding units. The object underlying the approach can also be achieved quickly and efficiently by this embodiment variant of the approach in the form of a device. The device can represent a door controller or can be integrated in a door control device.

For this purpose, the device can have at least one processing unit for processing signals or data, at least one storage unit for storing signals or data, at least one interface to a sensor or an actuator for inputting sensor signals from the sensor or for outputting data or control signals to the actuator, and/or at least one communication interface for inputting or outputting data, which are embedded in a communication protocol. The processing unit can be, for example, a signal processor, a microcontroller, or the like, wherein the storage unit can be a flash memory, an EPROM, or a magnetic storage unit. The communication interface can be designed to input or output data in a wireless and/or wired manner, wherein a communication interface which can input or output data in a wired manner can input these data, for example, electrically or optically from a corresponding data transfer line or can output these data into a corresponding data transfer line.

A device can be understood in the present case as an electrical apparatus which processes sensor signals and outputs control and/or data signals as a function thereof. The device can have an interface which can be designed as hardware and/or software. In a hardware design, the interfaces can be, for example, part of a so-called system ASIC, which contains greatly varying functions of the device. However, it is also possible that the interfaces are separate integrated circuits or at least partially consist of discrete components. In a software design, the interfaces can be software modules which are provided, for example, on a microcontroller in addition to other software modules.

A door system for a vehicle has the following features:

an embodiment of the above-mentioned device; and

the door, the at least one drive element, and the movement elements, wherein the at least one drive element is designed to effectuate the movement process of the door, wherein the movement elements participate in the movement process of the door, wherein the at least one drive element is connectable so it is capable of transmitting signals to the device embodied as a unit external to the vehicle or is connected to the device embodied as a unit internal to the vehicle.

If a device external to the vehicle is used, a data evaluation can be executed, for example, in a stationary server.

One embodiment of the above-mentioned device can advantageously be employed or used in the door system to provide maintenance information on the door system. The door system can also have at least one acquisition unit for acquiring the process data. The device can be connected so it is capable of transferring signals to the at least one acquisition unit. Optionally, the door system can also have a unit for executing an algorithm for state-dependent maintenance and additionally or alternatively an algorithm for predictive maintenance. The unit for execution can be connected in a manner capable of signal transfer to the device or can be embodied combined with the device.

A computer program product or computer program having program code which can be stored on a machine-readable carrier or storage medium such as a semiconductor memory, hard drive memory, or an optical memory and is used to carry out, implement, and/or activate the operations of the method according to one of the above-described embodiments is also advantageous, in particular if the program product or program is executed on a computer or a device.

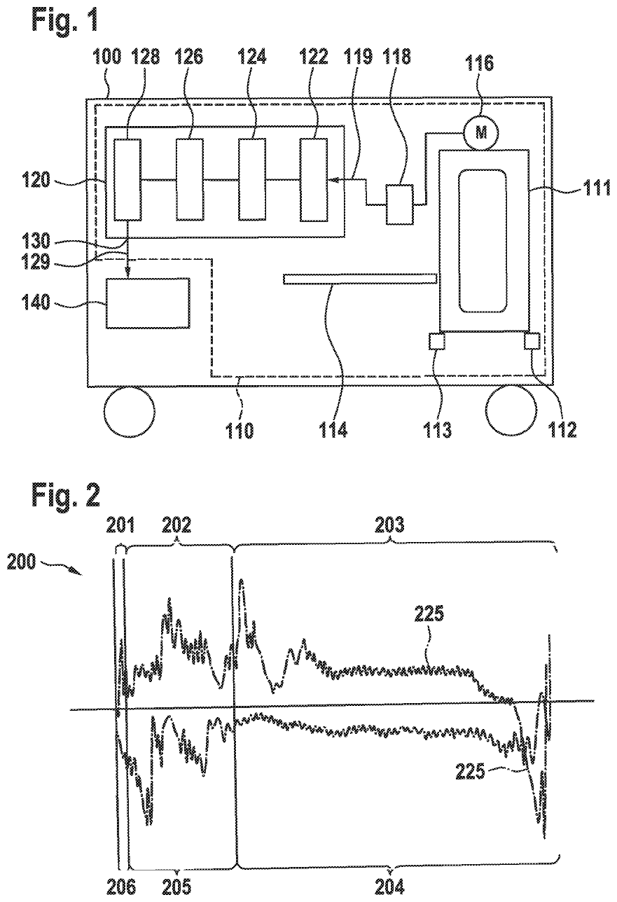

FIG. 1 shows a schematic illustration of a vehicle 100 having a door system 110 according to one exemplary embodiment. The vehicle 100 is, for example, a rail vehicle. The vehicle 100 has the door system 110. The door system 110 comprises a door 111, three movement elements 112, 113, and 114 solely by way of example, at least one drive element 116, and a provision device 120 or device 120 for providing maintenance information 129 on the door system 110. According to the exemplary embodiment described here, the door system 110 also comprises an acquisition unit 118. According to another exemplary embodiment, the acquisition unit 118 can also be provided separately from the door system 110 or integrated in the controller, which is implemented, for example, in the device 120.

The door 111 is arranged movably relative to a chassis of the vehicle 100. During a movement process of the door 111, during an opening process, first unlocking, followed by pivoting out, and finally a linear movement take place, and during a closing process, first a linear movement, followed by pivoting in, and finally locking take place. The at least one drive element 116 is designed to effectuate the movement process of the door 111. The drive element 116, which is shown in FIG. 1, is, for example, an electric motor or the like. Movement elements 112, 113, and 114 participate in the movement process of the door 111. In particular, in this case these elements are at least one locking unit 112, at least one pivot unit 113, and at least one guide unit 140.

The drive element 116 is connected to the acquisition unit 118 so it is capable of transferring signals. The acquisition unit 118 is connected to the device 120 so it is capable of transferring signals. A connection capable of transferring signals, therefore, exists between the drive element 116 and the device 120. The acquisition unit 118 is designed to acquire process data 119 with respect to the drive element 116 and, thus, with respect to the movement process and provide these data to the device 120. According to one exemplary embodiment, the acquisition unit 118 or the functionality implemented by the acquisition unit 118 is comprised by the device 120. The acquired process data 119 represent or characterize, for example, a power consumption of the drive element 116. In this case, the acquisition unit 118 is designed to acquire the power consumption of the drive element 116 and provide it as the acquired process data 119. Therefore, the process data 119 are provided, for example, in the form of an electrical signal indicating a time curve or distance-dependent curve of the power consumption.

The device 120 or provision device 120 has an input unit 122, a correlation unit 124, a comparison unit 126, and an assignment unit 128. The device 120 is designed to provide the maintenance information 129 on the door system 110. In other words, the device 120 is designed to determine the maintenance information 129 using the process data 119.

The tasks of the device 120 can also be executed wayside on a server, thus, the device 120 is or parts of the device 120 are implemented externally to the vehicle 100 according to one exemplary embodiment. A data transfer between the device 120 and the vehicle 100 can take place in a wireless manner, for example.

The input unit 122 of the device 120 is designed to input the acquired process data 119 with respect to the movement process of the door 111, more precisely to input these data via an interface to the acquisition unit 118. A current behavior of the drive element 116 during the movement process may be read from the process data 119. The input unit 122 is also designed to pass on the input process data 119 to the correlation unit 124 of the device 120, for example, in the form of a further electrical signal. The correlation unit 124 is designed to correlate the process data 119 with a position course of positions of the door 111 during the movement process, to generate a characteristic curve of the current behavior of the at least one drive element 116 at the positions of the door 111 assumed in the course of the movement process. The correlation unit 124 is also designed to pass on the generated characteristic curve to the comparison unit 126. The comparison unit 126 is designed to compare the characteristic curve generated by the correlation unit 124 to a reference characteristic curve to ascertain a deviation of the characteristic curve from the reference characteristic curve. The reference characteristic curve represents here a target behavior of the drive element 116 at the positions of the door 111 during the movement process. For example, the comparison unit 126 is designed to compare a time curve of the generated characteristic curve to the reference characteristic curve to ascertain the deviation. The comparison unit 126 is also designed to pass on the ascertained deviation to the assignment unit 128. The assignment unit 128 is designed to assign the ascertained deviation to a subsection of the positioning curve to determine the maintenance information 129. The position course is divided into a plurality of subsections in dependence on a participation of different movement elements 112, 113, and 114 of the door system 110 at different phases of the movement process of the door 111.

According to one exemplary embodiment, the input unit 122 is designed in particular to input the process data 119 in response to a door opening signal and/or a door closing signal of the door system 110. For this purpose, the device 120 can be connected so it is capable of transferring signals to an actuating unit for actuating the door 111. The input unit 122 is also designed according to one exemplary embodiment to input a sensor signal which specifies or represents the positions of the door 111 during the movement process.

The assignment unit 128 is designed according to one exemplary embodiment to determine first maintenance information 129 if the deviation is assigned to a first subsection of the movement process, at which a first subset of the movement elements participates, for example the at least one locking unit 112. Furthermore, the assignment unit 128 is designed here to determine second maintenance information 129 different from the first maintenance information 129 if the deviation is assigned to a second subsection of the movement process at which a second subset of the movement elements participates, for example, the at least one pivot unit 113 and/or the at least one guide unit 114.

The device 120 is also designed according to one exemplary embodiment to output the determined maintenance information 129 at an interface 130 to a unit 140 for executing an algorithm for state-dependent maintenance and/or an algorithm for predictive maintenance. For this purpose, the device 120 can have an output unit. The device 120 is also designed according to one exemplary embodiment to divide the position course into the plurality of subsections as a function of a participation of the different movement elements 112, 113, and 114 in the different phases of the movement process of the door 111. For this purpose, the device 120 can have a division unit. The division can be executed once for the door system 110.

FIG. 2 shows a schematic diagram of a reference characteristic curve 225 and of subsections 201, 202, 203, 204, 205, and 206 of a position course according to one exemplary embodiment. The reference characteristic curve 225 and the subsections 201, 202, 203, 204, 205, and 206 are used by the device to provide maintenance information from FIG. 1 or a similar device. In other words, the diagram of FIG. 2 shows a current curve over positions of the door during the movement process.

The position course of positions is plotted, for example, in pulses of a sensor signal of a position sensor or distance sensor on an abscissa axis of the diagram 200. A current or a power consumption of the drive element of the door system from FIG. 1 or a similar door system is plotted, for example, in milliamperes on an ordinate axis of the diagram 200.

The position course or door running action of the door system is classified or divided into kinematic elements, for example, six phases or subsections 201, 202, 203, 204, 205, and 206 per door cycle here. A first subsection 201 of the position course represents unlocking of the door of the door system. A second subsection 202 of the position course represents pivoting out of the door. A third subsection 203 represents linear opening of the door. The subsections 201, 202, and 203 represent an opening process of the door. A fourth subsection 204 represents linear closing of the door. A fifth subsection 205 represents pivoting in of the door. A sixth subsection 206 represents locking of the door.

With respect to the door system from FIG. 1, it is to be noted that in the first subsection 201 and in the sixth subsection 206, the at least one locking unit of the door system participates in the movement process, in the second subsection 202 and in the fifth subsection 205, the at least one pivot unit of the door system participates in the movement process, and in the third subsection 203 and in the fourth subsection 204, the at least one guide unit of the door system participates in the movement process.

Solely by way of example, the boundaries between phases or subsections according to the exemplary embodiment shown here are at approximately 10% pulses as the boundary between the first subsection 201 and the second subsection 202 or the fifth subsection 205 and the sixth subsection 206, respectively, and at approximately 30% pulses as the boundary between the second subsection 202 and the third subsection 203 or the fourth subsection 204 and the fifth subsection 205, respectively, each viewed from a rest position of the door in the closed state.

FIG. 3 shows a schematic comparison diagram 300 of a characteristic curve 323 and a reference characteristic curve 225 according to one exemplary embodiment. The reference characteristic curve 225 is the reference characteristic curve from FIG. 2. The characteristic curve 323 is generated by the device from FIG. 1 or a similar device. The comparison diagram 300 corresponds to the diagram from FIG. 2 with the exception that the characteristic curve 323 is superimposed on the reference characteristic curve 225.

In FIG. 3, by way of example, a deviation 327 exists between the reference characteristic curve 225 and the characteristic curve 323 in the second subsection 202 and a deviation 327 exists between the reference characteristic curve 225 and the characteristic curve 323 in the fifth subsection 205. The reference characteristic curve 225 represents the starting state or target state of the door system from FIG. 1 or a similar door system and the characteristic curve 323 results here, for example, by an angle interaction in the door system. The deviations 327, which are symbolically illustrated by ellipses, characterize regions in the comparison diagram 300 at which differences can be seen between the two curves, reference characteristic curve 225 and characteristic curve 323. These are in the pivoting out phase and in the pivoting in phase. According to this exemplary embodiment, the amplitudes of the reference characteristic curve 225 and the characteristic curve 323 differ in the fifth subsection. If a difference in absolute value of the amplitudes exceeds a threshold value, a deviation 327 exists according to one exemplary embodiment.

The deviations 327 are, therefore, ascertained according to one exemplary embodiment by analyzing the characteristic curves 323 in the time range/distance range in which the time/distance-dependent curves of the characteristic curves 323 are compared to time/distance-dependent curves of the reference characteristic curves 225. Additionally or alternatively, the deviations 327 are ascertained according to one exemplary embodiment by analyzing the characteristic curves 323, for example, in the frequency range, in which spectra of the characteristic curves 323 are compared to spectra of the reference characteristic curves 225.

The division of the position course into the subsections 201, 202, 203, 204, 205, and 206 enables anomalies recognized in the process data to be assigned to a kinematic phase, for example, the pivoting out. Therefore, in the event of an elevated power consumption of the entry system or door system within this subsection, causes of error which relate, for example, to the linear guide or guide unit can be technically completely excluded in the maintenance information. Settings of the door system can have been changed due to removal and installation of rotating columns in the course of a replacement of gear wheels, for example, due to which additional changes of the current curve and, thus, the deviations 327 could have been induced.

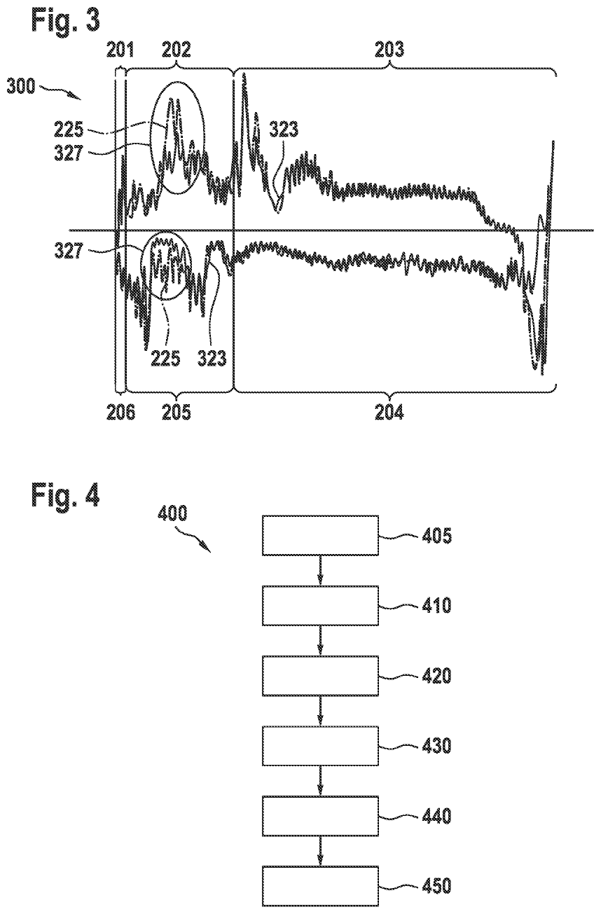

FIG. 4 shows a flow chart of a method 400 for providing according to one exemplary embodiment. The method 400 is executable to provide maintenance information on a door system for a vehicle. In this case, the method 400 for providing is executable by using the device from one of the above-described figures or a similar device. According to one exemplary embodiment, the method 400 is executed when a movement process of a door of a door system takes place. For example, the method 400 can be executed when a control unit for controlling the movement process indicates a beginning of the movement process, for example, using a control signal.

Depending on the embodiment of the device, the method 400 can be executed completely or partially either internally to the vehicle or externally to the vehicle.

In an operation 410 of inputting, acquired process data with respect to the movement process of the door of the door system are input. The process data represent a current behavior of at least one drive element of the door system during the movement process here. Subsequently, in an operation 420 of correlating, the process data are corrected using a position course of positions of the door during the movement process to generate a characteristic curve of the current behavior of the at least one drive element at the positions of the door. Subsequently in turn, in a operation 430 of comparing, the characteristic curve is compared to a reference characteristic curve which represents a target behavior of the at least one drive element at the positions of the door to ascertain a deviation of the characteristic curve from the reference characteristic curve. Then, in a operation 440 of assigning, the deviation is assigned to a subsection of the position course divided into a plurality of subsections in dependence on a participation of different movement elements of the door system in different phases of the movement process of the door, to determine the maintenance information.

According to one exemplary embodiment, the method 400 for providing has an operation 405 of dividing. In the operation 405 of dividing, the position course is divided into the plurality of subsections in dependence on a participation of the different movement elements of the door system in the different phases of the movement process of the door. The movement process divided into the subsections is used in operation 440 of assigning. Additionally or alternatively, the method 400 for providing has a operation 450 of outputting. In operation 450 of outputting, the maintenance information determined in operation 440 of assigning is output at an interface to a unit for executing an algorithm for state-dependent maintenance and/or an algorithm for predictive maintenance.

### LIST OF REFERENCE NUMERALS

100 vehicle
110 door system
111 door
112 locking unit
113 pivot unit
114 guide unit
116 drive element
118 acquisition unit
119 process data
120 device
122 input unit
124 correlation unit
126 comparison unit
128 assignment unit
129 maintenance information
130 interface
140 unit for execution
200 diagram
201 first subsection—unlocking
202 second subsection—pivoting out
203 third subsection—linear opening
204 fourth subsection—linear closing
205 fifth subsection—pivoting in
206 sixth subsection—locking
225 reference characteristic curve
300 comparison diagram
323 characteristic curve
327 deviation
400 method for providing
405 operation of dividing
410 operation of inputting
420 operation of correlating
430 operation of comparing
440 operation of assigning
450 operation of outputting

1. A method for providing maintenance information on a door system for a vehicle, wherein the method comprising:
inputting acquired process data with respect to a movement process of a door of the door system, wherein the process data represent a current behavior of at least one drive element of the door system during the movement process;
correlating the process data with a position course of positions of the door during the movement process to generate a characteristic curve of the current behavior of the at least one drive element at the positions of the door;
comparing the characteristic curve to a reference characteristic curve that represents a target behavior of the at least one drive element at the positions of the door to ascertain a deviation of the characteristic curve from the reference characteristic curve; and
assigning the deviation to a subsection of the position course divided into a plurality of subsections based on a participation of different movement elements of the door system in different phases of the movement process of the door to determine the maintenance information.

2. The method of claim 1, further comprising: dividing the position course into the plurality of subsections based on a participation of the different movement elements of the door system in the different phases of the movement process of the door.

3. The method of claim 1, wherein, in the operation of assigning, first maintenance information is determined if the deviation is assigned to a first subsection of the movement process, in which a first subset of the movement elements participates, wherein in the assigning, second maintenance information different from the first maintenance information is determined if the deviation is assigned to a second subsection of the movement process, in which a second subset of the movement elements participates.

4. The method of claim 1, wherein, in the inputting, the process data are input in response to a door opening signal and/or a door closing signal.

5. The method of claim 1, wherein, in the inputting, process data are input which represent a power consumption of the at least one drive element, and/or wherein in step of inputting, a sensor signal is input which represents the positions of the door during the movement process.

6. The method of claim 1, further comprising outputting the determined maintenance information at an interface to a unit for executing an algorithm for state-dependent maintenance and/or an algorithm for predictive maintenance.

7. The method claim 1, in which at least one of the inputting, correlating, comparing and assigning is executed partially or entirely externally to the vehicle.

8. A device for providing maintenance information on a door system for a vehicle, wherein the device is configured to execute and/or activate operations for providing the maintenance information on the door system for the vehicle by:
inputting acquired process data with respect to a movement process of a door of the door system, wherein the process data represent a current behavior of at least one drive element of the door system during the movement process;
correlating the process data with a position course of positions of the door during the movement process to generate a characteristic curve of the current behavior of the at least one drive element at the positions of the door;
comparing the characteristic curve to a reference characteristic curve that represents a target behavior of the at least one drive element at the positions of the door to ascertain a deviation of the characteristic curve from the reference characteristic curve; and
assigning the deviation to a subsection of the position course divided into a plurality of subsections based on a participation of different movement elements of the door system in different phases of the movement process of the door to determine the maintenance information.

9. The device of claim 8, which is embodied as a unit external to a vehicle or internal to a vehicle.

10. A door system for a vehicle, wherein the door system comprises:
a device as claimed in claim 8; and
the door;
the at least one drive element; and
the movement elements,
wherein the at least one drive element is designed to effectuate the movement process of the door,
wherein the movement elements participate in the movement process of the door,
wherein the at least one drive element is connectable to transferring signals to the device embodied as a unit external to the vehicle or is connected to the device embodied as a unit internal to the vehicle.

11. A non-transitory computer readable medium including a computer program, which is configured to execute and/or activate the method as claimed in claim 1.

12. (canceled)
